(19) United States
(12) Patent Application Publication
(10) Pub. No.: US 2025/0196369 A1
(43) Pub. Date: Jun. 19, 2025

(54) MATERIAL HANDLING SYSTEM AND METHOD THEREOF

(71) Applicant: Nanyang Technological University, Singapore (SG)

(72) Inventors: Guoqiang Hu, Singapore (SG); Kaige Shi, Singapore (SG)

(21) Appl. No.: 18/846,103

(22) PCT Filed: Mar. 13, 2023
(86) PCT No.: PCT/SG2023/050162

§ 371 Date: Sep. 11, 2024

(30) Foreign Application Priority Data
Mar. 29, 2022 (SG) 10202203182Y

(51) Int. Cl. B25J 15/06; B25J 9/16; B25J 15/00

(52) U.S. Cl. CPC B25J 15/0616; B25J 9/1612; B25J 15/0052

(57) ABSTRACT

A material handling system includes: a frame defining a first axis; a plurality of suction units coupled to the frame and distributed in rotational symmetry about the first axis; and at least one stopper. The plurality of suction units collectively defines a distal plane normal to the first axis, with each of the plurality of suction units being operable to provide a suction force in a suction direction parallel to the first axis. The at least one stopper is fixedly coupled to the frame and extends beyond the distal plane to provide one or more abutment ends disposed stationary relative to the frame. The one or more abutment ends define a transverse offset axis extending through all of the one or more abutment ends. The transverse offset axis is a straight line spaced apart from the first axis and parallel to the distal plane.

### CROSS-REFERENCE TO RELATED APPLICATION

This application claims the benefit of priority to the Singapore application no. 10202203182Y filed Mar. 29, 2022, the entire contents of which are hereby incorporated by reference for all purposes.

### TECHNICAL FIELD

This application relates to a material handling system and a method of controlling the material handling system.

### BACKGROUND

The conventional “non-contact” gripper generally requires some gripping or clasping some part of the workpiece in order to apply a sufficiently large force for carrying the workpiece from one location to another, e.g., in an automated production line. In the process of clasping the workpiece, the conventional gripper tends to create scratches, indentations, and other surface flaws, etc., on the workpiece, especially when the workpiece is relatively heavy or bulky. Some conventional grippers are specifically designed for and are limited for use with workpieces of certain weight, shape, physical dimensions, and/or materials property. For example, some conventional grippers cannot handle wet workpieces (e.g., newly coated printed circuit boards) or soft workpieces (e.g., foam mats). Some conventional grippers are not suitable for use with fragile workpieces (e.g., silicon wafers, solar cells, glass panels).

### SUMMARY

In one aspect, the present application discloses a material handling system. The material handling system includes: a frame defining a first axis; a plurality of suction units coupled to the frame and distributed in rotational symmetry about the first axis, the plurality of suction units collectively defining a distal plane normal to the first axis, each of the plurality of suction units being operable to provide a suction force in a suction direction parallel to the first axis; and at least one stopper, the at least one stopper being fixedly coupled to the frame and extending beyond the distal plane to provide one or more abutment ends disposed stationary relative to the frame, the one or more abutment ends defining a transverse offset axis extending through all of the one or more abutment ends, wherein the transverse offset axis is a straight line spaced apart from the first axis and parallel to the distal plane.

Preferably, the material handling system includes a controller coupled to the plurality of suction units, the controller being configured to control any one of the plurality of suction units independently of any other of the plurality of suction units.

In another aspect, the present application discloses a material handling system suitable for use with a workpiece having a workpiece surface and a workpiece edge, in which the plurality of suction units in operation provides a suction force on the workpiece in the suction direction towards the distal plane, and in which the workpiece surface facing the distal plane is spaced apart from the distal plane by an abutment of the one or more abutment ends with the workpiece edge.

In another aspect, the present application discloses a material handling system including a controller configured to control a method of material handling, the controller being configured to control each of the plurality of suction units to produce a respective suction force and a respective torque, wherein each of the respective suction force and the respective torque of any one of the plurality of suction units is independent of forces produced by any other of the plurality of suction units.

In another aspect, the present application discloses a method of controlling a material handling system, including: controlling a plurality of suction units coupled to a frame to provide a suction force on a workpiece surface of a workpiece in a suction direction parallel to a first axis, the plurality of suction units being distributed in rotational symmetry about the first axis and collectively defining a distal plane normal to the first axis; and providing at least one stopper in abutment with a workpiece edge of the workpiece, the at least one stopper being fixedly coupled to the frame and extending beyond the distal plane to provide one or more abutment ends disposed stationary relative to the frame, the one or more abutment ends defining a transverse offset axis extending through all of the one or more abutment ends, wherein the transverse offset axis is a straight line spaced apart from the first axis and parallel to the distal plane.

Preferably, each one of the plurality of suction units is controlled independently of any other of the plurality of suction units to keep the workpiece surface spaced apart from the distal plane by a spacing, wherein the spacing is controllably variable by varying a respective suction force of each of the plurality of suction units.

Preferably, each one of the plurality of suction units is controlled based on any one or more of the following: (i) a target trajectory of an angle between the workpiece surface and the distal plane, (ii) a target contact force between the workpiece and the at least one stopper, (iii) a target contact torque between the workpiece and the at least one stopper, (iv) at least one kinematics parameter of the frame.

### BRIEF DESCRIPTION OF THE DRAWINGS

Various embodiments of the present disclosure are described below with reference to the following drawings:

FIG. 1A is a schematic drawing of a material handling system according to an embodiment of the present disclosure.

FIG. 1B is a schematic diagram of a method of controlling the material handling system of FIG. 1A.

FIG. 2A is a perspective view of an end-effector of the material handling system of FIG. 1A.

FIG. 2B is a schematic drawing of the end-effector of FIG. 2A as viewed from a workpiece.

FIG. 2C is a schematic drawing of the end-effector according to another embodiment.

FIG. 3 is a side view and a detailed view of the end-effector of FIG. 2A.

FIGS. 4A to 4C are views of a stopper according to an embodiment.

FIGS. 5A to 5C are views of a stopper according to another embodiment.

FIG. 6 is a side view of a suction unit according to an exemplary embodiment.

FIG. 7 is a schematic drawing of a control system according to an embodiment of the present disclosure.

FIGS. 8A to 8D are top views of the end-effector illustrating net suction forces and net torques on a workpiece according to different control settings.

FIG. 9 is a side view of an end-effector and a workpiece.

FIG. 10 is a perspective view of the workpiece of FIG. 9 illustrating forces acting on the workpiece.

FIG. 11 is a schematic diagram of a dual control loop architecture according to an embodiment of the present disclosure.

FIG. 12 is a schematic diagram of a dual control loop architecture according to another embodiment.

FIG. 13 is a schematic diagram of a dual control loop architecture according to yet another embodiment.

### DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance as generally understood in the relevant technical field, e.g., within 10% of the specified value.

As used herein, the term “and/or” includes any and all combinations of one or more of the associated listed items.

As used herein, “comprising” means including, but not limited to, whatever follows the word “comprising”. Thus, use of the term “comprising” indicates that the listed elements are required or mandatory, but that other elements are optional and may or may not be present.

As used herein, “consisting of” means including, and limited to, whatever follows the phrase “consisting of”. Thus, use of the phrase “consisting of” indicates that the listed elements are required or mandatory, and that no other elements may be present.

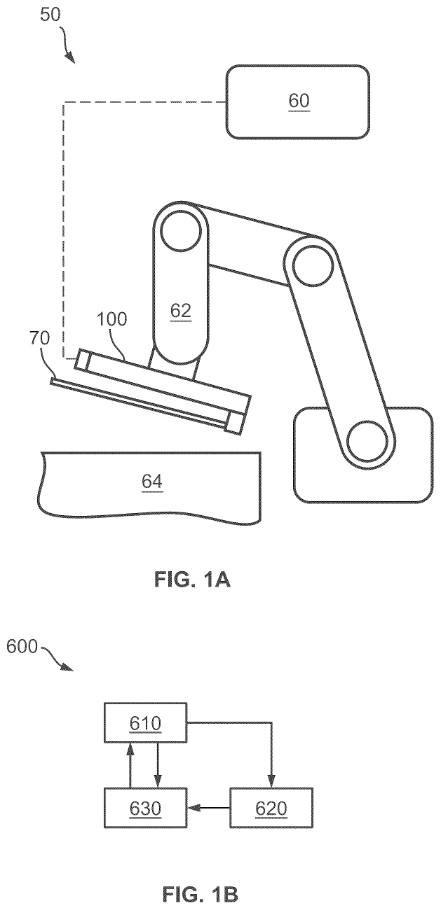

FIG. 1A illustrates a material handling system 50 with an end-effector 100 according to an embodiment of the present disclosure. The material handling system 50 may include a manipulator 62 to which the end-effector 100 is coupled. In operation, the end-effector 100 is in signal communication with or is coupled to a controller 60 configured to implement a control system. For the sake of brevity, the terms “controller” and “control system” may be used interchangeably, and it will be understood that the controller 60 may be embodied in the form of one or more devices or circuit components. The manipulator 62 is configured to controllably position or move the end-effector 100 and thereby manipulate various workpieces held by the end-effector 100. The end-effector 100 can be used to handle a workpiece 70. For example, the material handling system 50 may be configured to perform any one or more of the following operations: pick up the workpiece 70 from a stage 64, orientate the workpiece 70 in a desired orientation, place the workpiece on the stage 64, carry the workpiece to another location, etc. In this example, the workpiece 70 may be described as having a generally planar shape or having a substantially planar portion, although the proposed end-effector 100 is not limited in its application by the shape or physical dimensions of the workpiece 70. It will be understood that the workpiece 70 schematically illustrated in the appended drawings is merely one of many examples of various articles which can be handled by the end-effector 100 and the material handling system 50 of the present disclosure.

To aid understanding, the following will describe the material handling system 50 in conjunction with a method 600 of controlling the material handling system 50. As schematically illustrated in FIG. 1B, the method 600 includes controlling a plurality of suction units (as represented by block 610) and providing an abutment to a workpiece (as represented by block 620). The method 600 includes acquiring feedback (as represented by block 630) and responsively controlling or varying the forces applied by the plurality of the suction units to the workpiece.

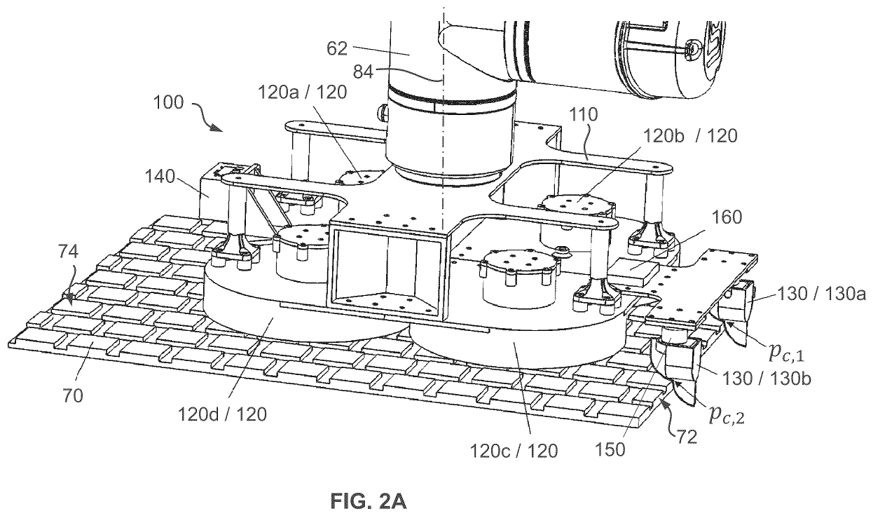

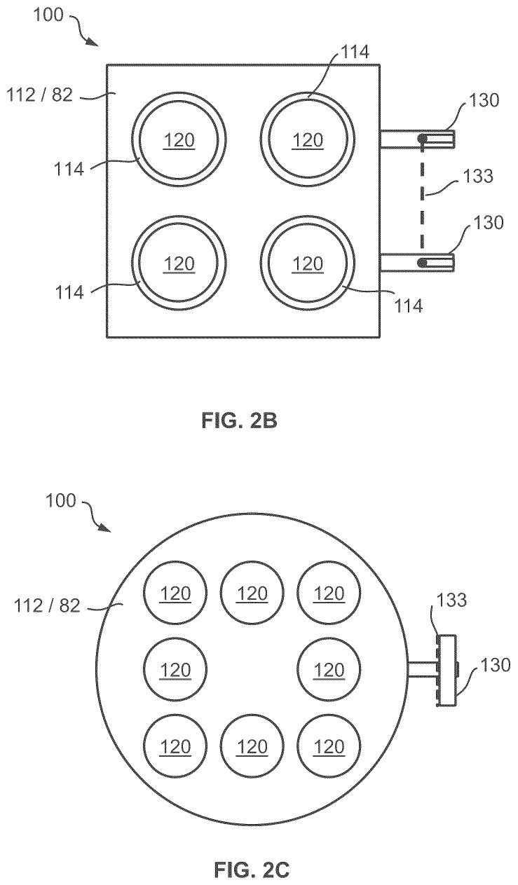

FIG. 2A presents a closer perspective view of the end-effector 100 in use with a non-limiting example of the workpiece 70. The end-effector 100 includes a frame 110 that can be detachably coupled to a working end of the manipulator 62, such that the end-effector 100 can be interchangeably used with different manipulators or robotic arms. The frame 110 may act as a primary load bearer to provide structural integrity to the end-effector 100. The frame 110 may include cut outs, openings, or apertures for light-weighting without affecting the structural integrity of the frame 110. Further, the frame 110 may serve to maintain a desired relative distance or position between components coupled to the frame 110.

The end-effector 100 includes a plurality of suction units 120. The frame 110 is coupled to each suction unit 120 such that all the suction units 120 are oriented axially in the same direction, i.e., in alignment with a first axis 84 defined by the frame 110. Referring also to FIG. 2B and FIG. 2C which show the end-effector 100 of different embodiments as viewed from a workpiece, the suction units 120 are preferably radially distributed about the first axis 84 in rotational symmetry. The suction units 120 are preferably spaced apart from the first axis 84 by a same radial distance. Each suction unit 120 is preferably spaced an equidistance from its two nearest neighboring suction units 120. The plurality of suction units 120 collectively form or define a distal plane 82. The plurality of suction units 120 are oriented parallel to the first axis 84 to collectively define the distal plane 82, with the distal plane 82 being normal to the first axis 84.

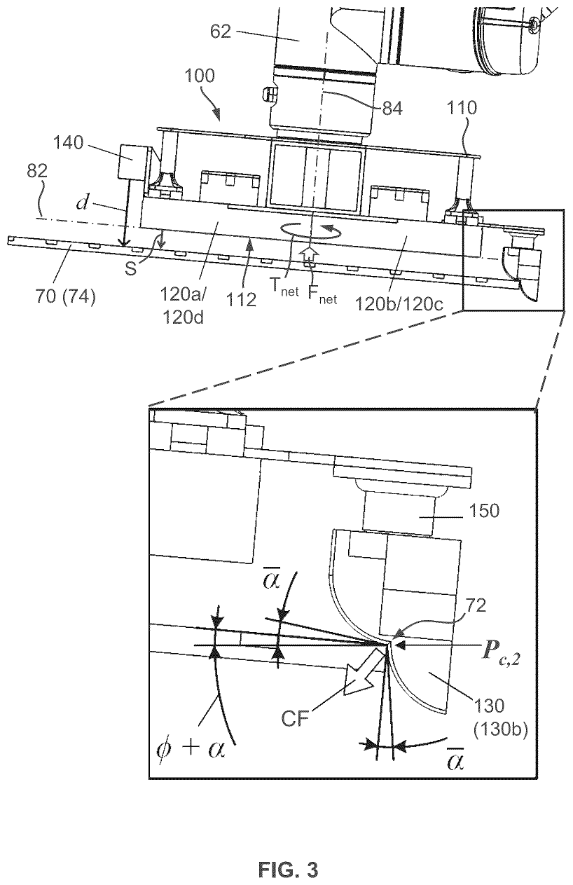

A plurality of suction units 120 may be coupled to the frame 110. In the embodiment illustrated by FIG. 2B, the frame 110 may define a plurality of recesses 114 in which the suction units 120 may be disposed interior of a respective recess 114 and fixedly coupled to the frame 110. As shown in FIG. 3, each of the suction units 120 may provide a respective suction force along a suction direction substantially parallel to the first axis 84. The controller 60 may independently control each of the suction units 120 to vary or control a net suction force (Fₙₑₜ) on the workpiece 70, i.e., the plurality of suction units are controllable independently of one another to provide a net suction force in the suction direction towards the distal plane 82, in which the net suction force is variable in magnitude (variable net suction force). In the present disclosure, the terms “suction force” and “lift force” may be used interchangeably, and terms such as “net suction force” are to be understood in the same manner. The net suction force (Fₙₑₜ) may be a sum of suction forces from each of the suction units 120. In some embodiments, the suction units 120 may be fans, each provided with a respective electronic speed control (ESC) controller for controlling a respective fan speed of the fan. In this embodiment, by operation of the fans, each of the suction units 120 may additionally provide a respective torque about a torque direction. Each of the fans may be controlled by the controller 60 to operate in any one of two directions to provide a torque in a corresponding one of two torque directions. A net torque (Tₙₑₜ) may be provided to the workpiece 70, which is based on a sum of torques from each of the suction units 120. Therefore, the controller 60 may independently control each of ESC controller to vary or control a net suction force (Fₙₑₜ) and/or a net torque (Tₙₑₜ) on the workpiece 70, i.e., to produce a variable net suction force and/or a variable net torque.

In some embodiments, the suction units 120 may be disposed in rotational symmetry about the first axis 84 of the frame 110 in which the first axis 84 is coincident with a central axis of the frame 110. In some embodiments, the suction units 120a/120b/120c/120d may be arranged rotationally symmetrical to each other about the first axis 84, in which the first axis 84 is normal to the distal plane 82. The first axis 84 may be substantially close to a center of mass of the frame 110. In some embodiments as shown in FIGS. 2 and 3, the first axis 84 may be coaxial to an end-effector axis of the manipulator 62.

The end-effector 100 may further include one or more stoppers 130 coupled to the frame 110. In some embodiments, each of the one or more stoppers 130 extends from the frame 110 and protrudes beyond the distal surface 112 (or the distal plane 82) of the frame 110 (towards the workpiece 70), such that at least one of the one or more stoppers 130 may be in contact or abut a workpiece edge 72 of the workpiece 70, with the workpiece surface 74 spaced apart from the distal surface 112 (or the distal plane 82). The workpiece edge 72 may be a continuous edge, a discontinuous edge, a curved edge, an uneven edge, etc. Preferably, the contact point(s) between the one or more stoppers 130 and the workpiece edge 72 is/are the only physical contact between the end-effector 100 and the workpiece 70 during the handling operation. Therefore, abutment between the workpiece edge 72 of the workpiece 70 limits the contact force and contact surface between the end-effector 100 and the workpiece 70. As shown, no other physical contact between the end-effector 100 and other parts of the workpiece 70 is required for the material handling system 100 to successfully handle the workpiece 70. It may be appreciated that the workpiece edge 72 of the workpiece may be selected for purpose of reducing the risk of physical damage or contamination with sensitive components/portions which are typically disposed near the center portion of the workpiece 70. For example, an edge spaced away from key electronic components of a printed circuit board (PCB) may be selected as the workpiece edge 72 for handling.

In some embodiments, the stoppers 130 may be provided with respective force sensors 150. For example, for embodiments of the end-effector 100 with two stoppers 130, each of the stoppers 130a/130b may be provided with a respective force sensor 150. The force sensor 150 may be a single axis force sensor, or a multiple axes force sensor for measuring a contact force (CF) between each of the stoppers 130a/130b and the workpiece 70. In some embodiments, a contact torque between each of the stoppers 130a/130b and the workpiece 70 may also be measured by the force sensor 150.

Referring again to FIGS. 2A and 3, the end-effector 110 may also include a distance sensor 140, such as a contactless distance sensor, coupled to the frame 110 for measuring a distance (d) between the distance sensor 140 and the workpiece 70. The distance sensor 140 is preferably disposed away from the distal surface 112 such that the distance sensor 140 does not protrude beyond the distal plane 82 towards the workpiece 70. The space separating the distance sensor 140 and the workpiece surface 74 is preferably unblocked. In other words, the distance (d) as measured preferably corresponds to a gap between the workpiece surface 74 and the distal plane 82 without having to compensate for variations introduced by the presence of other components positioned between the workpiece 70 and the distance sensor 140.

In some embodiments, the stoppers 130 and the distance sensor 140 may be coupled to a periphery or a side of the frame 110. In one embodiment, the stoppers 130 and the distance sensor 140 may be coupled to respective one or more sides of the frame 110. In some embodiments where there are two or more stoppers 130a/130b, the stoppers 130a/130b may be disposed spaced apart from each other. Preferably, the distance sensor 140 is disposed spaced apart from any one of the stoppers 130a/130b. Preferably, the distance sensor 140 is disposed diametrically opposite the transverse offset axis. In one example, the frame 110 may include a straight side. The stoppers 130a/130b may be coupled to the straight side of the frame with the distance sensor 140 coupled to another side of the frame 110. Preferably, all the stoppers 130a/130b are disposed on one side of the frame 110 such that each one of the stoppers forms a point contact with the workpiece edge 72, with the distance sensor 140 disposed on an opposing side of the frame 110. In other words, the distance sensor 140 is disposed spaced apart from any one of the at least one stopper 130. Preferably, the distance sensor 140 is disposed diametrically opposite the one or more stoppers 130.

In some embodiments, the end-effector 100 may also include an inertial measurement unit (IMU) 160 coupled to the frame 110. The IMU 160 may determine one or more kinematics parameters of the frame 110, such as displacement, velocity, acceleration, angular displacement, angular velocity, angular acceleration, etc. The controller 60 may be configured to control the suction units 120 based on one or more of the kinematics parameters determined by the IMU 160.

FIG. 3 illustrates the end-effector 100 in an operational state and handling a workpiece 70. In the present disclosure, an “upper surface” or a surface of the workpiece as viewed from the end-effector 100 is referred to as the workpiece surface 74 for the sake of brevity. That is, the workpiece surface 74 refers generally to a surface of the workpiece 70 that faces or is nearest to the distal plane 82 of the end-effector 100 when the workpiece 70 is handled by the end-effector 100. The end-effector 100 is operable even if the workpiece surface 74 is uneven, soft, and/or air-permeable (e.g., a flexible printed circuit board with open-ended vials). The end-effector 100 is also operable with workpieces with a grooved workpiece surface, a workpiece with through holes, a workpiece with a concave workpiece surface, a soft foam mat workpiece, etc.

During operation, the stoppers 130a/130b may be positioned by the manipulator 62 to abut the workpiece edge 72 of the workpiece 70, while the suction units 120a/120b/120c/120d controllably and collectively provide a net suction force (Fₙₑₜ) on the workpiece 70 along a suction direction. The suction direction is preferably parallel to the first axis 84 of the frame 110 and directed to lift the workpiece 70. The net suction force (Fₙₑₜ) is provided to overcome a weight of the workpiece 70 to displace or to lift the workpiece 70 towards the frame 110 (towards the distal plane 82). As the workpiece edge 72 comes into abutment with the one or more abutment ends 132 of the stoppers 130, further movement of the workpiece edge 72 towards the distal plane 82 is prevented. The one or more abutment ends 132 limits the movement of the workpiece edge 72 of the workpiece 70 towards the frame 110. The workpiece surface 74 facing the distal plane 82 is thereby spaced apart from the distal plane 82 by an abutment of the one or more abutment ends 130 with the workpiece edge 72. Under the suction forces provided by the suction units 120a/120b/120c/120d, the workpiece 70 angularly displaces about the stoppers 130. The net suction force (Fₙₑₜ) controllably provides and maintains a spacing (S) along the first axis 84 between the workpiece surface 74 and the distal plane 82 (or the distal surface 112) defined by the frame 110. This ensures that only the workpiece edge 72 of the workpiece 70 is in physical contact with the end-effector 100 while other parts of the workpiece 70 do not come into physical contact with the end-effector 100. The distance sensor 140 may be employed to determine the spacing (S) or to determine a change in the spacing (S) based on the distance (d) measured by the distance sensor 140. The controller 60 may be configured to controllably vary the spacing between the workpiece surface 74 and the distal plane 82 by varying a respective suction force of each of the plurality of suction units 120. The ability to dynamically adjust the spacing (S) enables the material handling system 50 to automatically reconfigure itself to ensure contactless handling. The only physical contact between the material handling system 50 and the workpiece 70 is only at one workpiece edge 72, and the end-effector 100 can be used with workpieces of various sizes and shapes without the need to change toolings to accommodate workpieces of different sizes or shapes. The end-effector 100 alone suffices in handling the workpiece 70 and there is no need for additional jigs or tools to contact or support the workpiece 70. The end-effector 100 thus offers greater flexibility in terms of the operational range of workpiece sizes as well as greater ease of use.

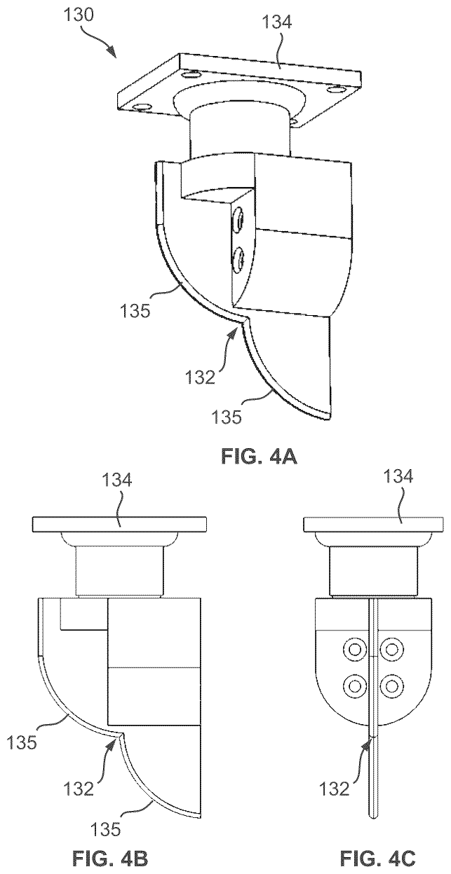

Referring to FIGS. 4A to 4C, an embodiment of the stopper 130 is illustrated in greater detail. The stopper 130 may include a coupling portion 134 for coupling to the frame 110. The stopper 130 is fixedly coupled to the frame 110 so that the stopper 130 is stationary relative to the frame 110. A part of the stopper 130 forms an abutment end 132, with the abutment end 132 being disposed stationary relative to the frame 110. The abutment end 132 may form a point contact or contact point (p_{c,2}) with the workpiece edge 72 of the workpiece 70.

In this example, the abutment end 132 may be formed at a convergence of two arcuate segments 135 as illustrated. The curvatures of the two arcs allow the angle (a) between the workpiece 70 and the stoppers 130a/130b to vary by an angle α̅ (i.e., α∈[−α̅, α̅], for example, between −5 degrees to +5 degrees) while maintaining the respective point contacts. In one example, the abutment end 132 may extend transversely or laterally relative to the workpiece edge 72 (when the abutment end 132 is in contact with the workpiece edge 72), such that substantially only a point contact is formed. With the provision of two of the stoppers 130a/130b as illustrated in FIGS. 2A to 2B, the stoppers 130a/130b may form two distinct point contacts with the workpiece edge 72, allowing the workpiece 70 to angularly displace relative to the frame 110/the stoppers 130a/130b. The abutment ends 132 may be described as defining a transverse offset axis 133 that extends through all of the abutment ends 132. The abutment ends 132 are disposed relative to the frame 110 such that the transverse offset axis 133 is spaced apart from the first axis 84 and parallel to the distal plane 82. Optionally, the transverse offset axis 133 is a straight line that coincides with an axis about which the workpiece 70 may angularly displace under varying suction forces provided by the section units 120, when the workpiece edge 72 is in abutment with the one or more stoppers 130. In examples where the workpiece edge 72 is substantially straight, the workpiece edge 72 may be substantially coincident with the transverse offset axis 133. However, as can be understood from the present disclosure, the end-effector 100 works as well when the workpiece edge 72 abuts only one abutment end 132 of one stopper 130, i.e., there is no limitation on the shape of the workpiece 70. For example, in some cases where the workpiece 70 is a wafer with a circular shape, the end-effector 100 may present one abutment end 132 to abut the workpiece edge 72 of the wafer in a line (linear) contact. In other examples, the end-effector 100 may present two abutment ends 132 to abut the workpiece edge of the wafer 72 in two spaced-apart point contacts. That is, the abutment end 132 may form a line contact with a circular workpiece edge of the workpiece 70, therefore allowing the end-effector 100 to handle a circular workpiece, such as a silicon wafer.

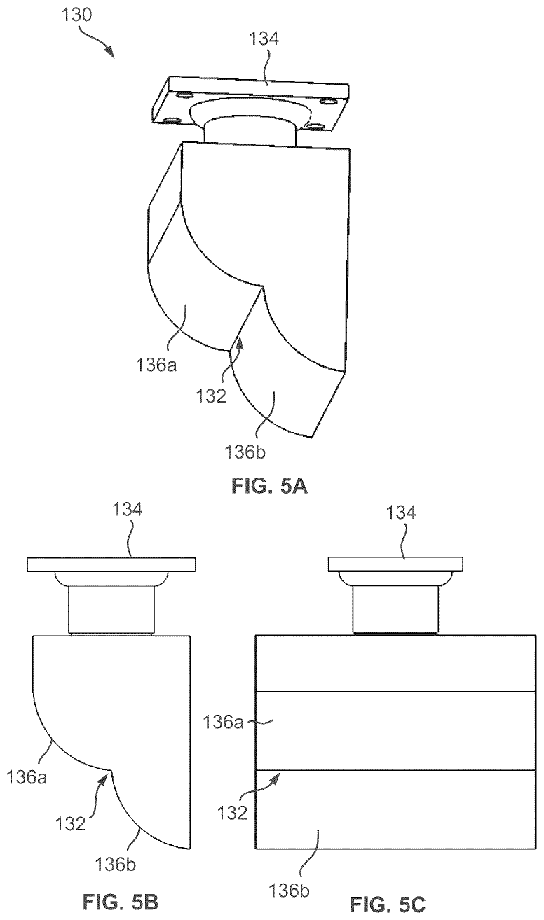

In another embodiment of the stopper 130, as shown in FIGS. 5A to 5C, the stopper 130 may include a coupling portion 134 for coupling to the frame 110 such that the stopper 130 (and parts thereof) is stationary relative to the frame 110. The stopper 120 includes a pair of convex or curved surfaces 136a/136b. The pair of curved surfaces 136a/136b may meet to define an abutment end 132. The abutment end 132 has a width enabling it to form a line contact with the workpiece edge 72 of the workpiece 72. In one example, the abutment end 132 may extend substantially parallel to the workpiece edge 72 during contact, such that a line contact is formed. With the provision of a single stopper 130 (e.g., FIG. 2C) of a certain width, the single abutment end 132 defines a transverse offset axis 133 extending through the whole abutment end 132. Similar to the embodiment with more than one abutment end (FIG. 2B), the manner in which the one or more abutment ends 132 releasably engage the workpiece edge 72 concurrently prevents the workpiece edge 72 from advancing further towards the distal plane 82 while allowing the workpiece 70 to angularly displace relative to the frame 110 or relative to the stopper 130.

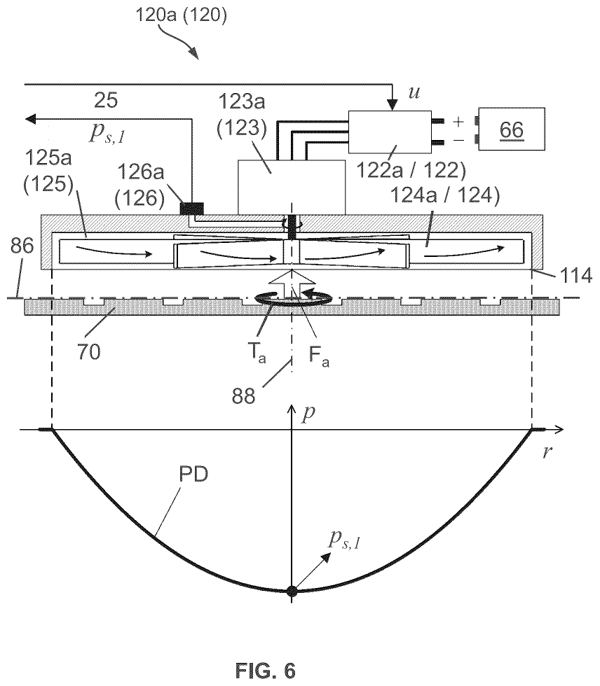

FIG. 6 illustrates an exemplary embodiment of one suction unit 120a, which may also be extended to other suction units 120. In this embodiment, the frame 110 may be formed with a recess 114 defining a chamber 125a, with the suction unit 120a disposed interior of the recess 114 or within the chamber 125a. Each of the suction units 120 may include a fan 124 rotatable about a fan axis 88. The fan 124a of the suction unit 120a may also include a motor 123a which rotates the fan 124a to generate a rotational airflow in the chamber 125a, thereby creating a quadratic vacuum pressure distribution. The vacuum pressure generates a suction force (Fₐ) with the rotational airflow inducing a torque (Tₐ). The magnitudes of the suction force (Fₐ) and the torque (Tₐ) may be controlled based on a fan speed of the fan 124a. The fan speed of the fan 214a further depends on an input voltage to the motor 123a. The suction unit 120a may be in signal communication with an ESC 122a which receives a respective control signal 25 comprising control inputs (u) from the controller 60 to draw on a direct current (DC) supply 66 and to control the input voltage to the motor 123a. In some embodiments, the direction of the torque (Tₐ) may be determined by a rotating direction of the fan 124a. Further, the suction unit 120a may include an embedded pressure sensor 126a for measuring a pressure (p_{s,1}) at the center of the chamber 125a.

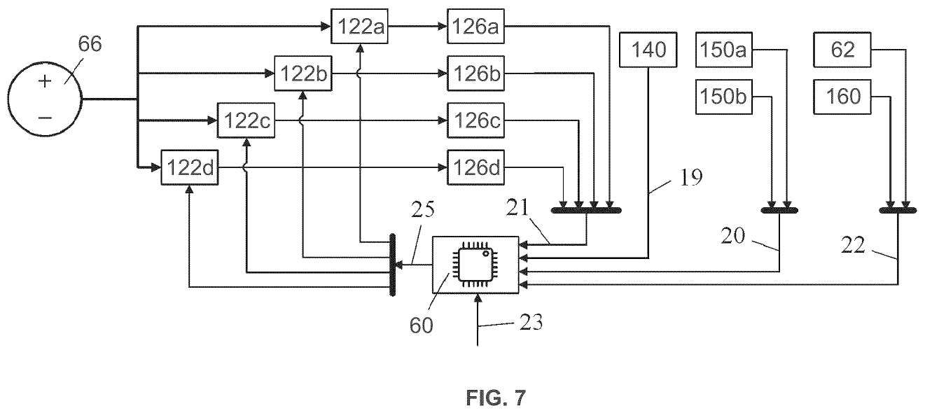

FIG. 7 illustrates an exemplary embodiment of a control system of the material handling system 50, presenting the respective signal communications between the control system and the components on the end-effector 100. The control system may include a controller 60 configured to receive utility signals in real time to compute the control inputs (u) to the ESCs. The utility signals may include distance (d) signal 19 from the distance sensor 140; contact force (CF) signal 20 from the force sensors 150a/150b; pressure (p_{s,1}) signal 21 from the pressure sensor 126; kinematics parameter signal 22 from the IMU unit 160 and/or the manipulator 62; and a command signal 23 which comprises target control values. The utility signals and control signals may be stored or alternatively continuously sent from an external source, such as an off-site system. Each of the utility signals and control signals may be transmitted wirelessly or through wires.

According to one embodiment of the material handling system 50, as shown in FIGS. 2A and 2B, the end-effector 100 may include four suction units 120 (120a/120b/120c/120d) arranged in a symmetric “X” configuration. With the provision of this configuration as an example, the rotating directions of the four suction units 120a/120b/120c/120d may be configured as described below. Preferably, to produce a controllable net torque (Tₙₑₜ) on the workpiece 70, the fans 124a/124c of suction units 120a/120c are configured to rotate counter-clockwise, while the fans 124b/124d of suction units 120b/120d are configured to rotate clockwise. In other words, in this embodiment, the controller may be configured to operate two diametrically opposing ones of the four suction units to produce respective clockwise torque, and to operate another two diametrically opposing ones of the four section units to produce respective anti-clockwise torque. Generally, the number of fans rotating in a first direction about the respective fan axis, such as in the counter-clockwise direction, is equal to the number of fans spinning in an opposing direction about the respective fan axis, such as in the clockwise direction. The provision of opposing torque from the four suction units 120a/120b/120c/120d allows for the net torque (Tₙₑₜ) on the workpiece 70 to be controllable, to be minimized or even be removed. Accordingly, such a configuration permits control over the net suction force (Fₙₑₜ) and net torque (Tₙₑₜ) on the workpiece 70 during operation of the end-effector 100.

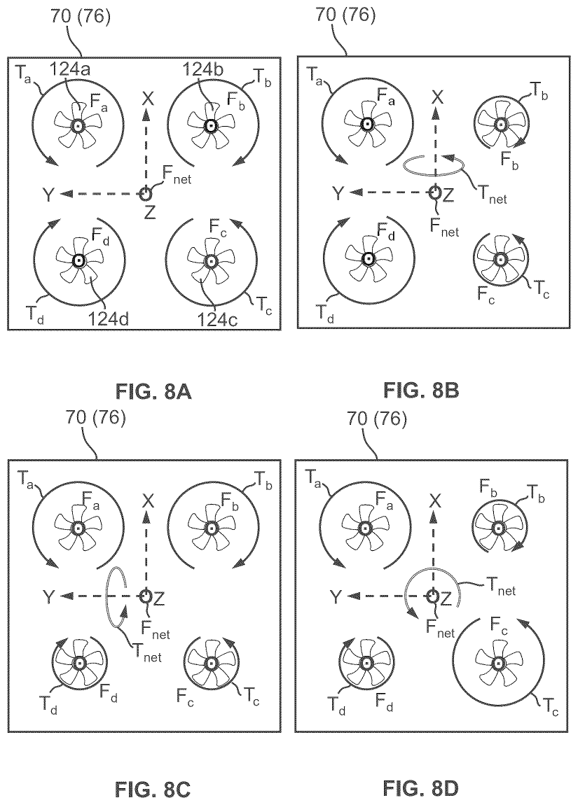

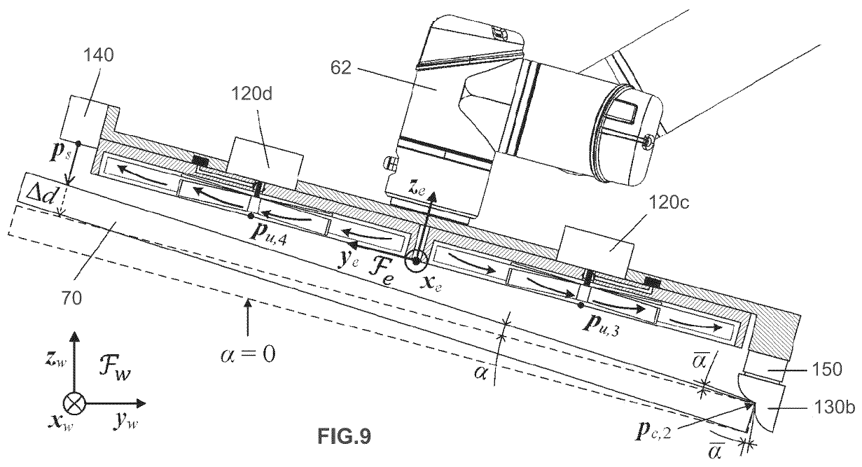

As illustrated in FIGS. 8A to 8D, the net suction force acting on the workpiece 70 results in a moment enabling the workpiece 70 to be angularly displaced about the at least one abutment end 130 (or the transverse offset axis 133), such that the workpiece 70 is generally lifted towards the frame 110. The net torque acting on the workpiece 70 (e.g., resulting from the differential torques produced by the fans 124) enables the workpiece 70 to be angularly displaced in the other directions.

With reference to FIGS. 8A to 8D, the following describes examples of producing variable net suction force (Fₙₑₜ) and net torque (Tₙₑₜ) on the workpiece 70. The controller 60 may be configured to vary control parameters, such as the fan speed for each of the suction units 120a/120b/120c/120d. The workpiece 70 may define a workpiece plane 76 generally planar to the workpiece 70. Referring to FIG. 8A, when the speeds of all fans 124a/124b/124c/124d are equal and set to above a threshold value, this provides a net suction force (Fₙₑₜ) in the Z direction with minimal net torque (Tₙₑₜ) on the workpiece 70. Referring to FIG. 8B, when the speed of fans 124a/124d is controlled to be faster relative to fans 124b/124c, a net suction force (Fₙₑₜ) in the Z direction and a net torque (Tₙₑₜ) about the X-axis is applied on the workpiece 70. Therefore, the suction units may apply a net torque (Tₙₑₜ) on the workpiece 70 about a lateral axis (X axis) planar to the workpiece plane 76. Referring to FIG. 8C, when the speed of fans 124a/124b is controlled to be faster relative to fans 124c/124d, a net suction force (Fₙₑₜ) in the Z direction and a net torque (Tₙₑₜ) about the Y-axis is applied on the workpiece 70. Similarly, the suction units may apply a net torque (Tₙₑₜ) on the workpiece 70 about another lateral axis (Y axis) planar to the workpiece plane 76. Referring to FIG. 8D, when the speed of fans 124a/124c is controlled to be faster relative to fans 124b/124d, a net suction force (Fₙₑₜ) in the Z direction and a net torque (Tₙₑₜ) about the Z-axis is applied on the workpiece 70. Therefore, the suction units may apply a net torque (Tₙₑₜ) on the workpiece 70 about an axis (Z axis) normal to the workpiece plane 76.

The control of net suction force (Fₙₑₜ) and net torque (Tₙₑₜ) on the workpiece 70 beneficially promotes stability between the workpiece 70 and the end-effector 100 during the course of material handling, including material transportation. In some embodiments, the control system or the controller 60 may control each of the suction units 120a/120b/120c/120d independently, i.e., be able to vary the respective suction force (Fₐ/F_{b}/F_{c}/F_{d}) and the respective torque (Tₐ/T_{b}/T_{c}/T_{d}) from each suction units 120a/120b/120c/120d on the workpiece 70, in response to external influences on the material handling system 50, such as a sudden acceleration or shock on the end-effector 100. Therefore, by controlling each of the suction units 120a/120b/120c/120d independently, the material handling system 50 is able to vary the net suction force (Fₙₑₜ) and the net torque (Tₙₑₜ) applied on the workpiece 70. In one example, responsive to a change in the orientation of the end-effector 100, the material handling system 50 may angularly displace the workpiece 70 or effect a change in angle (a) between the workpiece 70 and the end-effector 100, to control the spacing (S) between the workpiece 70 and the distal surface 112, to avoid contact or collision of the workpiece 70 with the distal surface 112. For example, the angle (a) may be controlled within the range of −5 to +5 degrees, with workpiece 70 being in contact with the end-effector 100 solely at the workpiece edge 72 of the workpiece 70.

In another embodiment, the control system may control each of the suction units 120a/120b/120c/120d independently of the other suction units to vary the respective contact force (CF) and/or the respective contact torque at an interface between the stoppers 130 and the workpiece edge 72. This may be done by independently varying the respective suction force (Fₐ/F_{b}/F_{c}/F_{d}) and the respective torque (Tₐ/T_{b}/T_{c}/T_{d}) of each of the suction units 120a/120b/120c/120d as described in earlier sections. When the contact force (CF) is minimal, a stability of the end-effector 100 holding the workpiece 70 may be less optimal. However, when the contact force (CF) is excessive, the workpiece 70 may be deformed from physical damage. Preferably, the controller 60 is configured to achieve a balance between end-effector/workpiece stability and limiting deformation to the workpiece 70, e.g., by controllably varying the contact force (CF) and/or contact torque by controlling each of the suction units 120a/120b/120c/120d independently of the other suction units 120.

In some embodiments, the controller 60 may control each of the suction units 120a/120b/120c/120d independently, by way of varying the respective suction force or fan speed of each suction units 120a/120b/120c/120d, based on a target trajectory of the angle (a) between the workpiece 70 and the distal plane 82. In an example, the target trajectory of the angle (a) is preferably in the range of −5 degrees to +5 degrees, i.e., a tolerance of ±5 degrees. In some embodiments, the controller 60 may control each of the suction units 120a/120b/120c/120d independently of other suction units 120, by way of varying the respective suction force or fan speed of each suction units 120a/120b/120c/120d, based on a target contact force between the workpiece 70 and the stoppers 130. In one example, a ratio between the target contact force and a weight of the workpiece 70 is controlled to be between 0.5:1 to 1:1. In other examples, the target contact force may be controlled between 0 N (Newtons) to 8 N. In some embodiments, the controller 60 may control each of the suction units 120a/120b/120c/120d independently, by way of varying the respective suction force or the fan speed of each suction units 120a/120b/120c/120d, based on a target contact torque between the workpiece 70 and the stoppers 130. In one example, the target contact torque is controlled to a minimal, preferably reduced to zero. In some embodiments, the controller 60 may be configured to control each of the suction units 120a/120b/120c/120d independently of any other of the suction units 120, by way of varying the respective suction force or fan speed of each suction units 120a/120b/120c/120d, based on a target contact force and a target contact torque, the target contact force and the target contact torque being between the workpiece 70 and the stoppers 130. In some embodiments, the control system may control each of the suction units 120a/120b/120c/120d independently, by way of varying the respective suction force or the fan speed of each suction unit 120a/120b/120c/120d, based on one or more kinematics parameter of the end-effector 100 or the manipulator 62, such as the displacement, velocity, acceleration, angular displacement, angular velocity, angular acceleration, etc.

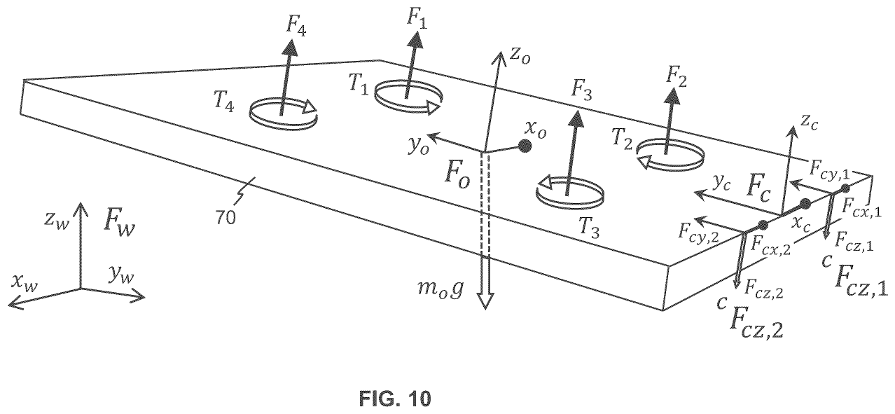

FIGS. 9 and 10 illustrate the kinematics of the end-effector 100 and the workpiece 70 according to one embodiment of the present disclosure. An inertial world frame [symbol] _{w} in which the gravitational acceleration is [0, 0, −g]^{T} with g≈9.8 m/s² is selected. The manipulator or manipulator's end is represented by a frame [symbol] ₑ. The position of [symbol] ₑ is pₑ∈ [symbol] ³ and the orientation is Rₑ=[xₑ, yₑ, zₑ]∈SO(3). The ZYX Euler angles corresponding to Rₑ is ηₑ=[ϕ, θ, ψ/]^{T}. The positions of the four suction units represented in [symbol] ₑ are ^{e}p_{u,1}=[lᵤ, lᵤ, 0]^{T}, ^{e}p_{u,2}=[lᵤ, −lᵤ, 0]^{T}, ^{e}p_{u,3}=[−lᵤ, −lᵤ, 0]^{T}, and ^{e}p_{u,4}=[−lᵤ, lᵤ, 0]^{T}, where lᵤ is a length constant. The contact points are fixed with respect to [symbol] ₑ, so ^{e}p_{c,1}=[l_{cx}, −l_{cy}, −l_{cz}]^{T} and ^{e}p_{c,2}=[−l_{cx}, −l_{cy}, −l_{cz}]^{T} where l_{cx}, l_{cy}, and l_{cz} are length constants. Then, a workpiece-fixed frame [symbol] _{c} is defined as follows: the position is p_{c}=(p_{c,1}+p_{c,2})/2; the x-axis is x_{c}=xₑ=(p_{c,1}−p_{c,2})/2l_{cx}; the z-axis z_{c} is perpendicular to the workpiece surface of workpiece 70 with z_{c}zₑ>0; the y-axis is y_{c}=z_{c}×x_{c}. Then, the ZYX Euler angles corresponding to R_{c}=[x_{c}, y_{c}, z_{c}]^{T} is η_{c}=[ϕ_{c}, θ_{c}, ψ_{c}]^{T}=[ϕ+α, θ, ψ]^{T}. The position of the contactless distance sensor 140 is ^{e}pₛ=[0, l_{sy}, l_{sz}]^{T} where l_{sy} and l_{sz} are length constants, so the actual value of α can be obtained as α=tan⁻¹[Δd/(l_{sy}+l_{cy})] where Δd=l_{sz}+l_{cz}−d with d being the reading of the distance sensor. The measured contact force at p_{c,j} represented in [symbol] _{c} is ^{c}F_{c,j}=[F_{cx,j}, F_{cy,j}, −F_{cz,j}]^{T} where j∈{1,2}.

The dynamics of the suction units 120a/120b/120c/120d are described as follows. For each suction unit, the central pressure p_{s,i}, is measured by the embedded pressure sensor, and its dynamics is \dot{p}_{s,i}, =aᵢuᵢ−bᵢp_{s,i}+d_{s,i}, where aᵢ and bᵢ are slowly time-varying constants, uᵢ∈[0, 1] is the throttle input to the ESC, d_{p,i} is the lumped disturbance, and i=1, 2, 3, and 4, representing each of the suction units 120a/120b/120c/120d, respectively. For each suction unit, aᵢ=2Uₛk_{m,i}c_{p,i}ωᵢ/J_{m,i}R_{m,i} and bᵢ=2k_{e,i}k_{m,i}/J_{m,i}R_{m,i}+2 c_{m,i}ωᵢ/J_{m,i} where Uₛ is the constant voltage of the DC supply 66, R_{m,i} is the internal resistance of the motor, J_{m,i} is the total rotational inertia of the motor's rotor and the fan, ωᵢ is the rotational velocity of the motor, k_{e,i} and k_{m,i} are the electrical and torque constants of the motor, c_{p,i} is the pressure coefficient of the suction unit, and c_{m,i} is the drag-torque coefficient of the suction unit. Thus, the combined dynamics of the four suction units is \dot{p}ₛ=Au−Bpₛ+dₚ, where pₛ=[p_{s,1}, p_{s,2}, p_{s,3}, p_{s,4}]^{T}, A=diag(a) with a=[a₁, a₂, a₃, a₄]^{T}, B=diag(b) with b=[b₁, b₂, b₃, b₄]^{T}, u=[u₁, u₂, u₃, u₄]^{T}, and dₚ=[d_{p,1}, d_{p,2}, d_{p,3}, d_{p,4}]^{T}. The above dynamics can be written in the linear regression form as Au−Bpₛ=Yₚ(pₛ, u)βₚ.

For each suction unit, the magnitudes of the respective generated suction force and torque are Fᵢ=c_{F,i}p_{s,i} and Tᵢ=c_{T,i}p_{s,i}, where c_{F,i} and c_{T,i} are force and torque coefficients of the suction unit, respectively. The coefficients c_{F,i} and c_{T,i} can be measured via experiments and may vary slightly with the position and orientation of the gripped workpiece. The values of c_{F,i} and c_{T,i} corresponding to the desired position and orientation of the workpiece 70 are denoted as ĉ_{F,i} and ĉ_{T,i}. In actual applications of the end-effector 100, the errors |ĉ_{F,i}−c_{F,i}| and |ĉ_{T,i}−c_{T,i}| are bounded.

The dynamics of the workpiece 70 (handled by the end-effector 100) is described as follows. Suppose the mass of the workpiece 70 is mₒ and the mass center is ^{c}pₒ=[lₒₓ, l_{oy}−l_{oz}]^{T}, then a workpiece-fixed frame [symbol] ₒ with position pₒ=p_{c}+R_{c}^{c}pₒ and orientation Rₒ=R_{c} can be defined. The inertia matrix of the workpiece 70 with respect to [symbol] ₒ is Iₒ=[Iₓₓ, −I_{xy}, −I_{zx}; −I_{xy}, I_{yy}, −I_{yz}; −I_{zx}, −I_{yz}, I_{zz}]. Applying the Euler-Lagrange equation, the dynamics of α is M\ddot{α}+G(α, \ddot{γ}, \dot{γ}, γ)=uₐ+dₐ, where M=mₒ(l_{oy}²+l_{oz}²)+Iₓₓ, γ=[p_{c}^{T} ηₑ^{T}]^{T} represents the pose of the end-effector 100, G represents Coriolis, centrifugal, and gravitational effects, u_{α}=J_{α}pₛ with J_{α}=[c_{F,1}(I_{cy}+Iᵤ), c_{F,2}(l_{cy}−lᵤ), c_{F,3}(l_{cy}−lᵤ), c_{F,4}(l_{cy}+lᵤ)]/cos α, and d_{α} is lumped unknown disturbance. The dynamics of α can also be written in the linear regression form as M\ddot{α}ᵣ+G(α, \ddot{γ}, \dot{γ}, γ)=Y_{α}(\ddot{α}ᵣα, \ddot{γ}, \dot{γ}, γ)β_{α}, where \ddot{α}ᵣ∈ [symbol] , βₐ=[β_{α0}, β_{α1}, β_{α2}, β_{α3}, β_{α4}, β_{α5}, β_{α6}, β_{α7}, β_{α8}, β_{α9}]^{T} is the vector of selected parameters with β_{α0}=mₒ(l_{oy}²+l_{oz}²)+Iₓₓ, β_{α1}=mₒ(l_{oz}²+lₒₓ²)+I_{yy}, β_{α2}=mₒ(lₒₓ²+l_{oy}²)+I_{zz}, β_{α3}=mₒlₒₓl_{oy}+I_{xy}, β_{α4}=mₒl_{oy}l_{oz}−I_{yz}, β_{α5}=mₒl_{oz}lₒₓ−I_{zx}, β_{α6}=mₒlₒₓ, β_{α7}=mₒl_{oy}, β_{α8}=−mₒl_{oz}, and β_{α9}=mₒ, and Y_{α}=[Y_{α0}, Y_{α1}, . . . , Y_{α9}] is the regressor matrix with Y_{α0}=\ddot{α}+\ddot{ϕ}−\ddot{ψ}s_{θ}−\dot{ψ}\dot{θ}c_{θ}, Y_{α1}=−(\dot{ψ}²c_{θ}²−\dot{θ}²)s_{α+ϕ}c_{α+ϕ}−\dot{θ}\dot{ψ}c_{θ}c_{2(α+ϕ)}, Y_{α2}=(\dot{ψ}²c_{θ}²−\dot{θ}²)s_{α+ϕ}c_{α+ϕ}+\dot{θ}\dot{ψ}c_{θ}c_{2(α+ϕ)}, Y_{α3}=−\ddot{θ}c_{α+ϕ}−\ddot{ψ}s_{α+ϕ}c_{θ}−\dot{ψ}²c_{α+ϕ}s_{θ}c_{θ}+2\dot{ψ}\dot{θ}s_{α+ϕ}s_{θ}, Y_{α4}=−(\dot{ψ}²c_{θ}²−\dot{θ}²)c_{2(α+ϕ)}+2\dot{ψ}\dot{θ}c_{θ}s_{2(α+ϕ)}, Y_{α5}=−\ddot{θ}s_{α+ϕ}+\ddot{ψ}c_{α+ϕ}c_{θ}−\dot{ψ}²s_{α+ϕ}s_{θ}c_{θ}−2\dot{θ}\dot{ψ}c_{α+ϕ}s_{θ}, Y_{α6}=0, Y_{α7}=\ddot{p}_{c,x(}s_{ψ}s_{α+ϕ}+c_{ψ}c_{α+ϕ}s_{θ})−\ddot{p}_{c,y}(c_{ψ}s_{α+ϕ}−s_{ψ}c_{α+ϕ}s_{θ})+(\ddot{p}_{c,z}+g)c_{α+ϕ}c_{θ}, Y_{α8}=−\ddot{p}_{c,x}(s_{ψ}c_{α+ϕ}−c_{ψ}s_{α+ϕ}s₀)+\ddot{p}_{c,y}(c_{ψ}c_{α+ϕ}+s_{ψ}s_{α+ϕ}s_{θ})+(\ddot{p}_{c,z}+g)s_{α+ϕ}c_{θ}, and Y_{α9}=0. Here, s_{(⋅)} and c_{(⋅)} denote sin(⋅) and cos(⋅), respectively. Further, a vector of variables σ is defined in which σ=[σ₁, σ₂, σ₃]^{T} with σ₁=F_{cz,1}+F_{cz,2}, σ₂=l_{cx}(F_{cz,1}−F_{cz,2}), and σ₃=l_{cx}(F_{cy,1}−F_{cy,2}). σ is related to the contact forces at p_{c,1} and p_{c,2}. According to the dynamics of the workpiece 70, Y_{σ}(\ddot{α}, \dot{α}, α, \ddot{γ}, \dot{γ}, γ) β_{α}=u_{σ}+σ+d_{σ}, where u_{σ}=J_{σ}pₛ with J_{σ}=[−c_{F,1}, −c_{F,2}, −c_{F,3}, −c_{F,4}; −c_{F,1}lᵤ, −c_{F,2}lᵤ, c_{F,3}lᵤ, c_{F,4}lᵤ; c_{T,1}, −c_{T,2}, c_{T,3}, −c_{T,4}], d_{σ} is the disturbance, Y_{σ}=[Y_{σ00}, . . . , Y_{α09}; Y_{σ10}, . . . , Y_{α19}; Y_{σ20}, . . . , Y_{α29}] is the regressor matrix with Y_{σ0j}=0 for ∀ j∈{0, 1, 2, 3, 4, 5}, Y_{σ06}=\ddot{θ}c_{α+ϕ}+\ddot{ψ}s_{α+ϕ}c_{θ}+\dot{ψ}²c_{α+ϕ}s_{θ}c_{θ}−2\dot{ψ}\dot{θ}s_{α+ϕ}s_{θ}, Y_{σ07}=−\ddot{α}−\ddot{ϕ}+\ddot{ψ}s_{θ}−(\dot{ψ}²c_{θ}²−\dot{θ}²)s_{α+ϕ}c_{α+ϕ}+2\dot{ψ}\dot{θ}s_{α+ϕ}²c_{θ}, Y_{σ08}=−\dot{θ}²c_{α+ϕ}²−(\dot{α}+\dot{ϕ})²−\dot{ψ}²(1−c_{α+ϕ}²c_{θ}²)+2(\dot{α}+\dot{ϕ})\dot{ψ}s_{θ}−\dot{ψ}\dot{θ}cθs_{2(α+ϕ)}, Y_{σ09}=−\ddot{p}_{c,x}(s_{ψ}s_{α+ϕ}+c_{ψ}c_{α+ϕ}s_{θ})+\ddot{p}_{c,y}(c_{ψ}s_{α+ϕ}−s_{ψ}c_{α+ϕ}s_{θ})−(\ddot{p}_{c,z}+g)c_{α+ϕ}c_{θ}, Y_{σ10}=−(\dot{α}+\dot{ϕ}−\dot{ψ}s_{θ})(\dot{θ}s_{α+ϕ}−\dot{ψ}c_{α+ϕ}c_{θ}), Y_{σ11}=\ddot{θ}c_{α+ϕ}+c_{θ}s_{α+ϕ}−(\dot{α}+\dot{ϕ})\dot{θ}s_{α+ϕ}−\dot{ψ}\dot{θ}s_{θ}s_{α+ϕ}+(\dot{α}+\dot{ϕ})\dot{ψ}c_{θ}c_{α+ϕ}, Y_{σ12}=(\dot{α}+\dot{ϕ}−\dot{ψ}s_{θ})(\dot{θ}s_{α+ϕ}−\dot{ψ}c_{α+ϕ}c_{θ}), Y_{σ13}=\ddot{ψ}s_{θ}−(\ddot{α}+\ddot{ϕ})+2\dot{ψ}\dot{θ}s_{α+ϕ}²c_{θ}+(\dot{θ}²−\dot{ψ}²c_{θ}²)s_{α+ϕ}c_{α+ϕ}, Y_{σ14}=−\ddot{θ}s_{α+ϕ}+\ddot{ψ}c_{α+ϕ}c_{θ}+\dot{ψ}²s_{θ}c_{θ}s_{α+ϕ}−2(\dot{α}+\dot{ϕ})\dot{ψ}c_{θ}s_{α+ϕ}−2(\dot{α}+\dot{ϕ})\dot{θ}c_{α+ϕ}, Y_{σ15}=−(\dot{α}+\dot{ϕ})²−\dot{ψ}²(s_{θ}²−c_{θ}²c_{α+ϕ}²)+\dot{θ}²s_{α+ϕ}²+2(\dot{α}+\dot{ϕ})\dot{ψ}s_{θ}−2\dot{ψ}\dot{θ}c_{θ}s_{α+ϕ}c_{α+ϕ}, Y_{σ16}=−\ddot{p}_{c,x}(s_{ψ}s_{α+ϕ}+c_{ψ}c_{α+ϕ}s_{θ})+\ddot{p}_{c,y}(c_{ψ}s_{α+ϕ}−s_{ψ}c_{α+ϕ}s_{θ})−(\ddot{p}_{c,z}+g)c_{α+ϕ}c_{θ}, Y_{σ17}=0, Y_{σ18}=−\ddot{p}_{c,x}c_{ψ}c_{θ}−\ddot{p}_{c,y}s_{ψ}c_{θ}+(\ddot{p}_{c,z}+g)s_{θ}, Y_{σ19}=0, Y_{σ20}=−(\dot{α}+\dot{ϕ}−\dot{ψ}s_{θ})(\dot{θ}c_{α+ϕ}+\dot{ψ}s_{α+ϕ}c_{θ}), Y_{σ21}=(\dot{α}+\dot{ϕ}−\dot{ψ}s_{θ})(\dot{θ}c_{α+ϕ}−\dot{ψ}s_{α+ϕ}c_{θ}), Y_{σ22}=\ddot{ψ}c_{α+ϕ}c_{θ}−\ddot{θ}s_{α+ϕ}−(\dot{α}+\dot{ϕ}+\dot{ψ}s_{θ})\dot{θ}c_{α+ϕ}−(\dot{α}+\dot{ϕ})\dot{ψ}s_{α+ϕ}c_{θ}, Y_{σ23}=\dot{θ}²c_{α+ϕ}²−(\dot{α}+\dot{ϕ})²+\dot{ψ}²(s_{α+ϕ}²c_{θ}²−s_{θ}²)+2(\dot{α}+\dot{ϕ})\dot{ψ}s_{θ}+\dot{ψ}\dot{θ}s_{2(α+ϕ)}c_{θ}, Y_{σ24}=\ddot{θ}c_{α+ϕ}+\ddot{ψ}c_{θ}s_{α+ϕ}−\dot{ψ}²c_{α+ϕ}s_{θ}c_{θ}+2(\dot{α}+\dot{ϕ})\dot{ψ}c_{α+ϕ}c_{θ}−2(\dot{α}+\dot{ϕ})\dot{θ}s_{α+ϕ}, Y_{σ25}=−\ddot{ψ}s_{θ}+(\ddot{α}+\ddot{ϕ})−(\dot{ψ}²c_{θ}²−\dot{θ}²)s_{α+ϕ}c_{α+ϕ}−2\dot{ψ}\dot{θ}c_{α+ϕ}²c_{θ}, Y_{σ26}=\ddot{p}_{c,x}(−s_{ψ}c_{α+ϕ}+c_{ψ}s_{α+ϕ}s_{θ})+\ddot{p}_{c,y}(c_{ψ}c_{α+ϕ}+s_{ψ}s_{α+ϕ}s_{θ})+(\ddot{p}_{c,z}+g)s_{α+ϕ}c_{θ}, Y_{σ27}=−\ddot{p}_{c,x}c_{ψ}c_{θ}−\ddot{p}_{c,y}s_{ψ}c_{θ}+(\ddot{p}_{c,z}+g)s_{θ}, Y_{σ28}=0, and Y_{σ29}=0.

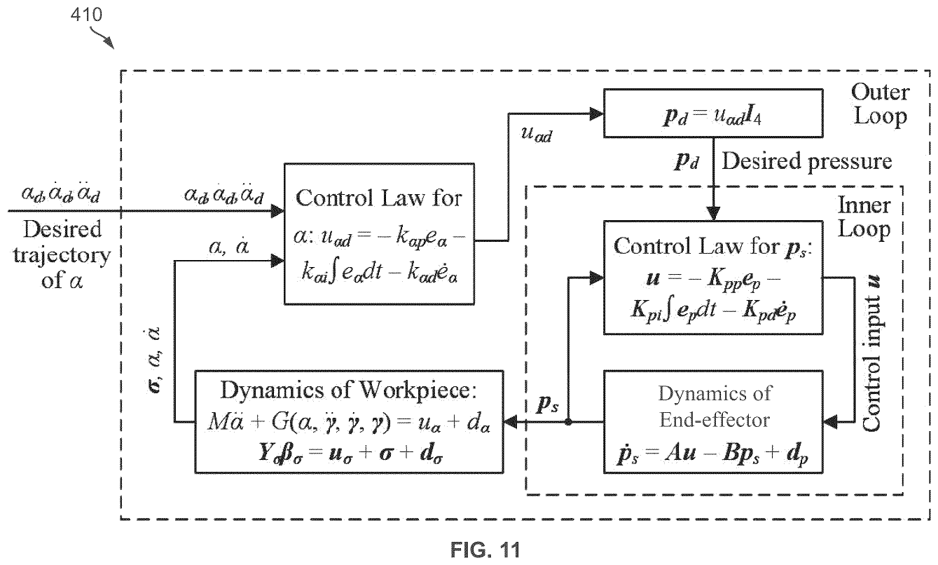

FIGS. 11 to 13 illustrate embodiments of a dual control loop architecture or a dual control loop control method. The architecture may include two closed loops, provided based on the above dynamic models of the end-effector 100 and the workpiece 70. The dual control loop architecture may be implemented by the controller 60. As an example, the controller 60 may include a microcomputer with a microprocessor unit, input/output ports, and an electronic storage medium for executable programs and calibration data.

FIG. 11 illustrates a dual control loop architecture 410 according to an embodiment. One objective of the dual control loop architecture 410 is to make α (angular displacement of workpiece 70) track a desired trajectory α_{d} or a target trajectory of the angle of the workpiece 70. As an example, the target trajectory is between −5 degrees to +5 degrees. PID control algorithms may be implemented for the dual control loop architecture as depicted in FIG. 11. The material handling system 50 may be divided into two loops with the control algorithm designed in a cascaded manner. In the outer loop, a pseudo input u_{αd} is calculated as u_{αd}=−k_{αp}e_{α}−k_{αi}∫e_{α}dt−k_{αd}ė_{α}, where e_{α}=α−α_{d} is the tracking error of α, and k_{αp}, k_{αi}, and k_{αd} are positive constants. Thereafter, the desired output pressure p_{d} of the four suction units is calculated as p_{d}=u_{αd}I₄, where I₄ is a 4-by-4 identity matrix. In the inner loop, PID control law is applied to make pₛ track p_{d}: u=−Kₚₚeₚ−Kₚᵢ∫eₚdt−K_{pd}ėₚ, where eₚ=pₛ−p_{d} is the tracking error of pₛ, and K_{αp}, K_{αi}, and K_{αd} are positive definite gain matrices. The above-described embodiment of the closed-loop control method controls only α, therefore, the force sensors of the stoppers are not utilized in this embodiment.

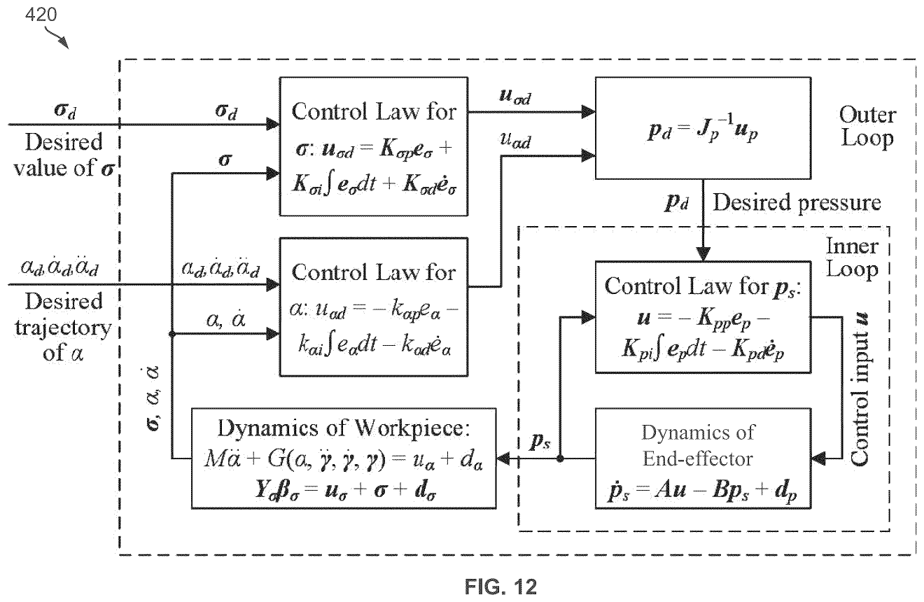

In a second embodiment of the dual control loop architecture 420 as shown in FIG. 12, in addition to the embodiment of FIG. 11, the architecture 420 is configured such that σ (related to the contact force and the contact torque between the workpiece 70 and the stoppers 130) tracks the desired value σ_{d} or a target contact force and/or target contact torque between the workpiece 70 and the stoppers 130. In one example, a ratio between the target contact force and a weight of the workpiece 70 is between 0.5:1 to 1:1. In some examples, the target contact force is between 0 to 8N. In another example, the target contact torque is zero. This architecture 420 achieves both objectives (tracking desired trajectory α_{d} and desired value σ_{d}) simultaneously. In the outer loop, a pseudo input u_{αd} is calculated as u_{αd}=−k_{αp}e_{α}−k_{αi}∫e_{α}dt−k_{αd}ė_{α}, and another pseudo input u_{σd} is calculated as u_{σd}=K_{σp}e_{σ}+K_{σi}∫e_{σ}dt+K_{σd}ė_{σ}, where e_{σ}=σ−σ_{d} is the tracking error of σ, and K_{σp}, K_{σi}, and K_{σd} are positive definite gain matrices. After that, the desired output pressure p_{d} is computed as p_{d}=Jₚ⁻¹uₚ where Jₚ=[J_{α}^{T}, J_{σ}^{T}]^{T} and uₚ=[u_{αd}, u_{σd}^{T}]^{T}. In the inner loop, the final control law is constructed as u=−Kₚₚeₚ−Kₚᵢ∫eₚdt−K_{pd}ėₚ, which is the same as that in the first embodiment. This embodiment requires force sensor(s) 150 coupled to the stoppers 130.

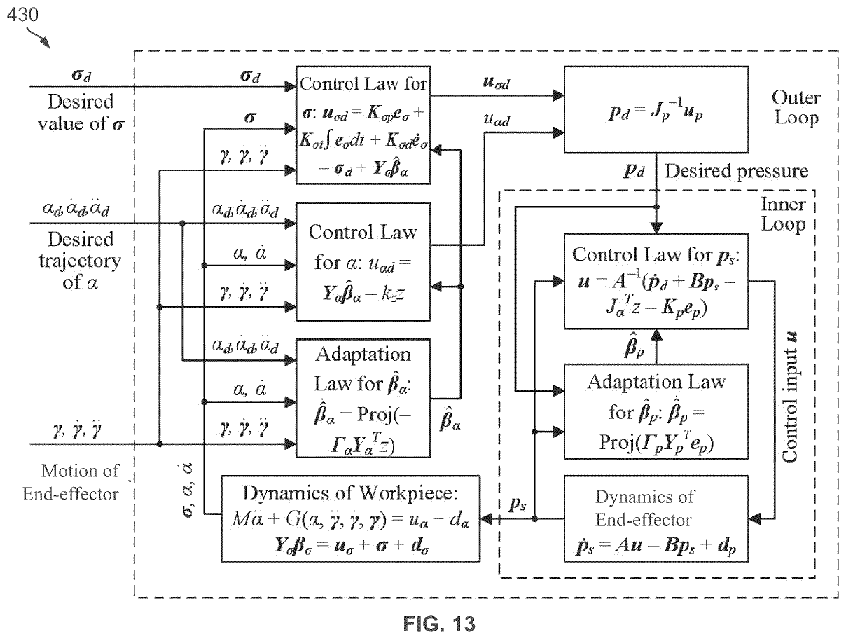

In a third embodiment of the dual control loop architecture 430 as shown in FIG. 13, effects due to motion of the end-effector 100 or the kinematics parameters of the end-effector, are compensated by the dual control loop architecture 430, by use of at least one kinematics parameter of the end-effector 100/frame 110, i.e., γ, \dot{γ}, and \ddot{γ} measured by the IMU unit 160 or calculated based on a motion of the manipulator 62. As the mass and inertia matrix of the workpiece 70 for calculating the compensation term is unknown, the control method estimates the parameters of the workpiece 70 as well as the parameters of the four suction units 120a/120b/120c/120d. An adaptive robust control is adopted for the outer loop. A sliding variable is defined as z=ė_{α}+k_{α}e_{α}, where k_{α} is a positive constant gain. The control law for α is u_{αd}=u_{αc}+u_{αr}, where u_{αc}=Y_{α}(\ddot{α}ᵣ, α, \ddot{γ}, \dot{γ}, γ)\hat{β}_{α} with \ddot{α}ᵣ=\ddot{α}_{d}−k_{α}ė_{α} is the adaptive compensation control term, and u_{αr}=−k_{z}z with k_{z} a positive constant gain is the robust control term. Here, \hat{β}_{α} is the estimation of β_{α} updated according to \hat{\dot{β}}_{α}=Proj(−Γ_{α}Y_{α}^{T}z), where Γ_{α} is a constant positive definite matrix, and Proj(⋅) is a projection function. Furthermore, the control law for σ is u_{σd}=K_{σp}e_{σ}+K_{σi}∫e_{σ}dt+K_{σd}ė_{σ}−σ_{d}+Y_{σ}(\ddot{α}_{d}, \dot{α}, α, \ddot{γ}, \dot{γ}, γ)\hat{β}_{α}. With u_{αd} and u_{σd}, the final control law of the outer loop is p_{d}=Jₚ⁻¹uₚ where Jₚ=[J_{α}^{T}, J_{σ}^{T}]^{T} and uₚ=[u_{αd}, U_{σd}^{T}]^{T}. The following adaptive robust control is adopted for the inner loop. The final control law is u=Â⁻¹(\dot{p}_{d}+\hat{B}pₛ−J_{α}^{T}z+uₚᵣ), where uₚᵣ=−Kₚeₚ is a robust control term with Kₚ a positive definite gain matrix. Here, Â and \hat{B} are estimations of A and B based on the estimation \hat{β}ₚ of βₚ. Meanwhile, \hat{β}ₚ is updated according to \hat{\dot{β}}ₚ=Proj(ΓₚYₚ^{T}eₚ), where Γₚ is a constant positive definite matrix.

As described above, the method 600 of controlling a material handling system 50 includes controlling a plurality of suction units 120 coupled to a frame 110 to provide a suction force on a workpiece surface 74 of a workpiece 70 in a suction direction parallel to a first axis 84, the plurality of suction units 120 being distributed in rotational symmetry about the first axis 84 and collectively defining a distal plane 82 normal to the first axis 84. The method 600 includes providing at least one stopper 130 in abutment with a workpiece edge 72 of the workpiece 70, the at least one stopper 130 being fixedly coupled to the frame 110 and extending beyond the distal plane 82 to provide one or more abutment ends 132 disposed stationary relative to the frame 110, the one or more abutment ends 132 defining a transverse offset axis 133 extending through all of the one or more abutment ends 132, wherein the transverse offset axis 132 is a straight line spaced apart from the first axis 84 and parallel to the distal plane 82.

Preferably, each one of the plurality of suction units 120 is controlled independently of any other of the plurality of suction units 120 to keep the workpiece surface 74 spaced apart from the distal plane 82 by a spacing, wherein the spacing is controllably variable by varying a respective suction force of each of the plurality of suction units 120.

Preferably, each one of the plurality of suction units 120 is controlled based on any one or more of the following: (i) a target trajectory of an angle between the workpiece surface 74 and the distal plane 82, (ii) a target contact force between the workpiece 70 and the at least one stopper 130, (iii) a target contact torque between the workpiece 70 and the at least one stopper 130, (iv) at least one kinematics parameter of the frame 110.

A prototype of the proposed material handling system 50 was used in a series of experiments to verify its ability to handle various types of workpieces. Table 1 lists some examples of workpieces used in the experiments.

TABLE 1
Examples of workpieces

| | | Dimensions | |
|---|---|---|---|
| Workpiece | Weight (g) | (mm*mm*mm) | Material |
| Workpiece with flat | 609 | 380*280*6 | Photosensitive |
| workpiece surface (501) | | | resin |
| Workpiece with grooved | 609 | 380*280*6 | Photosensitive |
| workpiece surface (502) | | | resin |
| Workpiece with through | 593 | 380*280*5 | Photosensitive |
| holes (503) | | | resin |
| Workpiece with curved | 457 | 380*280*27 | Photosensitive |
| workpiece surface (504) | | | resin |
| Silicon wafer (505) | 127 | Φ300*0.8 | Silicon |
| Acrylic sheet (506) | 212 | 280*240*3 | Acryl |
| PCB (507) | 380 | 360*220*3 | Polycarbonate |
| LED screen panel (508) | 481 | 827*300*1.5 | Glass |
| Carton box (509) | 391 | 532*354*79 | Paper |
| Foam mat (510) | 337 | 420*400*30 | Polyurethane |
| Wood board (511) | 308 | 450*300*5 | Wood |
| Foam board (512) | 63 | 600*454*12 | Polystyrene |
| Corrugated board (513) | 147 | 598*500*3 | Polypropylene |
| Aluminum plate (514) | 822 | 336*300*3 | Aluminum |

As experimentally demonstrated, the proposed material handling system 50 can handle workpieces of different size, thickness, dimensions, shape, weight, geometry, material, etc., without the need for additional physical jigs and tools, and without the need to replace physical components of the material handling system 50. The experiments confirm that the proposed material handling system 50 can safely handle fragile workpieces (such as glass panels, solar cells, silicon wafers, etc.) as well as workpieces that may be sensitive to contaminations, external forces/pressures, thermal effects, etc. The experiments also verify that the proposed material handling system 50 can handle wet workpieces such as freshly coated PCBs, and soft workpieces such as foam mats. Advantageously, the experiments demonstrated the ability of the proposed material handling system 50 to handle workpieces that are substantially larger than the end-effector 100, e.g., LED screen panels (dimensions of 827 mm by 300 mm by 1.5 mm). The experiments also demonstrated that the forces produced by the end-effector 100 are large enough to handle relatively heavy workpieces, e.g., aluminum plate of over 822 g.

The material handling system 50 can be particularly useful in high-mix low-volume (MILV) manufacturing (although not limited to such applications) where frequent tool changes to accommodate different types of workpieces would severely impact production efficiency. Further, the material handling system 50 is able to overcome multiple technical limitations such as potential physical damage, contamination, thermal damage, etc., by enabling material handling without contacting any part of the workpiece surface 74 and minimally contacting one workpiece edge 72.

1. A material handling system, comprising:
a frame defining a first axis;
a plurality of suction units coupled to the frame and distributed in rotational symmetry about the first axis, the plurality of suction units collectively defining a distal plane normal to the first axis, each of the plurality of suction units being operable to provide a suction force in a suction direction parallel to the first axis; and
at least one stopper, the at least one stopper being fixedly coupled to the frame and extending beyond the distal plane to provide one or more abutment ends disposed stationary relative to the frame, the one or more abutment ends defining a transverse offset axis extending through all of the one or more abutment ends, wherein the transverse offset axis is a straight line spaced apart from the first axis and parallel to the distal plane.

2. The material handling system as recited in claim 1, comprising a controller coupled to the plurality of suction units, the controller being configured to control any one of the plurality of suction units independently of any other of the plurality of suction units.

3. The material handling system as recited in claim 2, wherein the plurality of suction units are controllable independently of one another to provide a variable net suction force in the suction direction.

4. The material handling system as recited in claim 2, wherein the frame defines a plurality of chambers, each of the plurality of suction units comprises a fan disposed in a respective one of the chambers, the fan being controllable by the controller to operate in any one of two directions to provide a torque in a corresponding one of two torque directions.

5. The material handling system as recited in claim 4, wherein the plurality of suction units are controllable independently of one another to provide a variable net torque.

6. The material handling system as recited in claim 2, comprising a distance sensor coupled to the frame, wherein the distance sensor is disposed spaced apart from any one of the at least one stopper.

7. The material handling system as recited in claim 6, wherein the distance sensor is disposed diametrically opposite the transverse offset axis.

8. The material handling system as recited in claim 2, comprising an inertial measurement unit coupled to the frame, wherein the inertial measurement unit is configured to measure at least one kinematics parameter of the frame.

9. The material handling system as recited in claim 8, wherein the controller is configured to independently control the plurality of suction units based on the at least one kinematics parameter of the frame.

10. The material handling system as recited in claim 2, wherein the plurality of suction units in operation provides a suction force on a workpiece in the suction direction towards the distal plane, and wherein a workpiece surface of the workpiece facing the distal plane is spaced apart from the distal plane by an abutment of the one or more abutment ends with a workpiece edge of the workpiece.

11. The material handling system as recited in claim 10, wherein the controller is configured to controllably vary a spacing between the workpiece surface and the distal plane by varying a respective suction force of each of the plurality of suction units.

12. The material handling system as recited in claim 10, wherein the plurality of suction units comprises four suction units distributed in rotational symmetry about the first axis, and wherein the controller is configured to operate two diametrically opposing ones of the four suction units to produce respective clockwise torque, and wherein the controller is configured to operate another two diametrically opposing ones of the four section units to produce respective anti-clockwise torque.

13. The material handling system as recited in claim 10, wherein the frame comprises a straight side, and wherein the at least one stopper comprises two stoppers coupled to the straight side such that each one of the two stoppers forms a point contact with the workpiece edge.

14. The material handling system as recited in claim 10, wherein the controller is configured to control each of the plurality of suction units to produce a respective suction force and a respective torque, and wherein each of the respective suction force and the respective torque of any one of the plurality of suction units is independent of forces produced by any other of the plurality of suction units.

15. The material handling system as recited in claim 14, wherein the controller is configured to control the plurality of suction units based on any one or more of the following: (i) a target trajectory of an angle between the workpiece surface and the distal plane, (ii) a target contact force between the workpiece and the at least one stopper, (iii) a target contact torque between the workpiece edge and the at least one stopper, and (iv) at least one kinematics parameter of the frame.

16. (canceled)

17. (canceled)

18. (canceled)

19. (canceled)

20. The material handling system as recited in claim 15, wherein the target contact torque is zero.

21. (canceled)

22. The material handling system as recited in claim 14, wherein the controller is configured to vary a contact force and a contact torque by controlling at least one of the respective torque, and wherein the contact force and the contact torque are at an interface between the workpiece edge and the at least one stopper.

23. A method of controlling a material handling system, comprising:
controlling a plurality of suction units coupled to a frame to provide a suction force on a workpiece surface of a workpiece in a suction direction parallel to a first axis, the plurality of suction units being distributed in rotational symmetry about the first axis and collectively defining a distal plane normal to the first axis; and
providing at least one stopper in abutment with a workpiece edge of the workpiece, the at least one stopper being fixedly coupled to the frame and extending beyond the distal plane to provide one or more abutment ends disposed stationary relative to the frame, the one or more abutment ends defining a transverse offset axis extending through all of the one or more abutment ends, wherein the transverse offset axis is a straight line spaced apart from the first axis and parallel to the distal plane.

24. The method as recited in claim 23, wherein each one of the plurality of suction units is controlled independently of any other of the plurality of suction units to keep the workpiece surface spaced apart from the distal plane by a spacing, wherein the spacing is controllably variable by varying a respective suction force of each of the plurality of suction units.

25. The method as recited in claim 24, wherein each one of the plurality of suction units is controlled based on any one or more of the following: (i) a target trajectory of an angle between the workpiece surface and the distal plane, (ii) a target contact force between the workpiece and the at least one stopper, (iii) a target contact torque between the workpiece and the at least one stopper, (iv) at least one kinematics parameter of the frame.
